(19) United States
(12) Patent Application Publication
(10) Pub. No.: US 2003/0229711 A1
(43) Pub. Date: Dec. 11, 2003

(54) Apparatus for gathering and providing status information from and to a number of unspecified persons and method for processing status information

(76) Inventors: Mi Hwa Cho, Yongin-shi (KR); Myung Rai Cho, Seongnam-shi (KR)

Correspondence Address: Michael A. Cantor, Philmore H. Colburn II, 55 Griffin South Road, Bloomfield, CT, 06002, US

(21) Appl. No.: 10/166,933

(22) Filed: Jun. 11, 2002

(51) Int. Cl. G06F 15/16

(52) U.S. Cl. 709/231

(57) ABSTRACT

An apparatus for gathering status information from a number of unspecified information providers through a communication network such as Internet and providing the status information to a number of unspecified information users accessing the Internet, and a method for processing the status information are provided. The apparatus includes a status information receiving unit for receiving status information, which is classified by districts and themes, from at least one information provider terminal through a communication network in a streaming method; a status information storage unit for storing the status information received through the status information receiving unit by districts and themes in order of status information generation time or status information reception time; a web server for providing a web page through which a status information reception request signal is received from at least one information user terminal, analyzing the received status information reception request signal, and generating a realtime relay request signal or a streaming transmission request signal; a realtime relay unit for receiving the realtime relay request signal from the web server, receiving status information, which is selected by at least one information user from among the status information which is being received in real time, from the status information receiving unit, and relaying the selected status information to the at least one information user terminal requesting the reception in real time; and a streaming transmission unit for receiving the streaming transmission signal from the web server, retrieving status information of a classification item selected by the information user from the status information storage unit, and transmitting the status information to the at least one information user terminal requesting the reception in a streaming method.

### BACKGROUND OF THE INVENTION

1. Field of the Invention

The present invention relates to an apparatus for gathering and providing status information through a communication network and a method for processing the status information, and more particularly, to an apparatus for gathering status information from a number of unspecified information providers through a communication network such as Internet and providing the status information to a number of unspecified information users accessing it through the Internet, and a method for processing the status information.

2. Description of the Related Art

With a recent rapid increase in use of the Internet and portable terminal devices such as portable phones and personal digital assistants (PDAs), status information is gathered and provided through a communication network in various ways. Here, status information indicates information that is directly gathered on the actual spot by an information provider using a portable terminal device and that is not made up and is defined to be composed of video data only or combination of video data and at least one of audio data and text data.

In a conventional method for gathering and providing status information, a few information providers (for example, network reporters or newspapermen) gather information about limited themes on line or off line and artificially select, edit, and revise the gathered information by themes at a separate editorial room before posting it on a web site. After the information is posted on the web site, information users who access the web site can search information about a desired theme and receive the information about the theme by selecting it. Alternatively, a number of unspecified information providers gather various kinds of information and post them on a web site with titles in a simple array, and thereafter, information users access the web site and select a title from among the titles given to the various kinds of information to receive desired information given the title.

The web site providing status information may not provide gathered status information to information users in real time but may gather status information for a predetermined term and perform classification, selection, edition, and revision on the gathered information in a bundle before providing the status information to information users.

In such conventional method for gathering and providing status information, it is almost impossible to relay status information gathered by a number of unspecified information providers to a number of unspecified information users in real time. In the conventional method, experts classify gathered status information by themes and/or districts to allow information users to easily search the status information and produce extra video information to simply introduce the content of the status information of each classification item at one time through complex editorial processes using editorial equipment. This costs a great deal.

In addition, when gathered status information is provided to information users after going through a series of processes such as classification, selection, edition, and revision, it takes a large amount of time for information users to be provided with the status information. Accordingly, in the case where gathered status information is real-time information such as a news flash or incident/accident information, the conventional method cannot satisfy the timeliness of the information, thereby lowering the value of the information. Even in the case of a broadcasting station relaying news flashes or sports in real time, fragmentary status information is limitedly relayed only in a time zone set by the programming department, and it is impossible to simultaneously relay status information gathered by a number of unspecified information providers to a number of unspecified information users in real time.

Consequently, according to the conventional method for gathering and providing status information, a time delay and an extra cost are incurred while status information is gathered and goes through processes of classification, selection, edition, and revision, so the conventional method cannot satisfy information users desiring to be quickly provided with various kinds of information.

### SUMMARY OF THE INVENTION

To solve the above-described problems, Applicants provide herein an apparatus for gathering and providing status information to gather status information, which is previously classified by districts and themes, from a number of unspecified information providers using a streaming method, relay the gathered status information to a number of unspecified information users in real time or store and/or manage the gathered status information in order of generation time or reception time, and provide the status information to a number of unspecified information users requesting the reception of the status information in real time using a streaming method; and a method for processing the status information.

More particularly, an apparatus is provided for gathering and providing status information for a number of unspecified users. The apparatus includes a status information receiving unit for receiving status information, which is classified by districts and themes, from at least one information provider terminal through a communication network in a streaming method; a status information storage unit for storing the status information received through the status information receiving unit by districts and themes in order of status information generation time or status information reception time; a web server for providing a web page through which a status information reception request signal is received from at least one information user terminal, analyzing the received status information reception request signal, and generating a realtime relay request signal or a streaming transmission request signal; a realtime relay unit for receiving the realtime relay request signal from the web server, receiving status information, which is selected by at least one information user from among the status information which is being received in real time, from the status information receiving unit, and relaying the selected status information to the at least one information user terminal requesting the reception in real time; and a streaming transmission unit for receiving the streaming transmission signal from the web server, retrieving status information of a classification item selected by the information user from the status information storage unit, and transmitting the status information to the at least one information user terminal requesting the reception in a streaming method.

The realtime relay unit receives the status information, which is selected by the at least one information user from among the status information which is being received in real time, from the status information receiving unit and relays the status information to all information user terminals requesting the reception in real time according to a multicasting method.

The apparatus further includes a decoding unit for receiving the status information, which is being received in real time, from the status information receiving unit, decoding the status information, generating still images at predetermined intervals, and selecting a representative still image from among the still images generated for each piece of status information which has been completely received.

The web server posts the still images indicating the status information being under realtime relay on the web page, posts representative still images indicating status information of different classification items stored in the status information storage unit on the web page, and receives the status information reception request signal from the at least one information user terminal.

The web server posts representative still images indicating latest status information by classification items prior to other representative still images of previous status information and sequentially posts the representative still images of the previous status information in descending order of time according to selection of the information user.

There is also provided a method for processing status information. The method includes the steps of (a) receiving status information, which is classified by districts and themes, from at an information provider terminal through a communication network in a streaming method; (b) storing the status information in a status information storage unit by districts and themes in order of status information generation time or status information reception time; (c) generating still images while decoding the status information which is received in real time and posting the still images on a web page to indicate status information which can be relayed in real time; and (d) relaying status information corresponding to a still image selected by an information user from among the still images posted on the web page to the information user's terminal.

In the step (c), the still images are generated at predetermined intervals.

In step (d), the status information is relayed in real time to all information user terminals, which request reception of the status information, according to a multicasting method.

The method further includes the steps of (e) selecting a representative still image for each piece of status information whose realtime reception is completed and posting the representative still image in a corresponding classification item on the web page; and (f) retrieving status information, which corresponds to a representative still image selected by an information user from among representative still images posted on the web page, from the status information storage unit and transmitting the status information to the information user's terminal in a streaming method.

In the step (e), representative still images indicating latest status information by classification items are posted prior to other representative still images of previous status information, and the representative still images of the previous status information are sequentially posted in descending order of time according to selection of the information user.

### BRIEF DESCRIPTION OF THE DRAWINGS

The above features and advantages of the present invention will become more apparent by describing in detail preferred embodiments thereof with reference to the attached drawings in which:

FIG. 1 is a block diagram of an apparatus for gathering and providing status information according to the present invention and environments thereof;

FIG. 2A is a block diagram of a first embodiment of an apparatus for gathering and providing status information according to the present invention;

FIG. 2B is a block diagram of a second embodiment of an apparatus for gathering and providing status information according to the present invention;

FIG. 3 is a schematic diagram showing an example of a structure of information provider information managed by an information provider management unit of an apparatus for gathering and providing status information according to the present invention;

FIG. 4 is a diagram showing an example of a structure of status information data managed by a status information storage unit of an apparatus for gathering and providing status information according to the present invention;

FIG. 5 is a flowchart of a procedure for processing status information according to the present invention;

FIG. 6 is a diagram showing an example of a procedure in which an information provider terminal transmits status information to an apparatus for gathering and providing status information according to the present invention; and

FIG. 7 shows an example of a web page which a web server of an apparatus for gathering and providing status information according to the present invention provides to an information user terminal.

### DETAILED DESCRIPTION OF THE INVENTION

Hereinafter, embodiments of the invention will be described in detail with reference to the attached drawings.

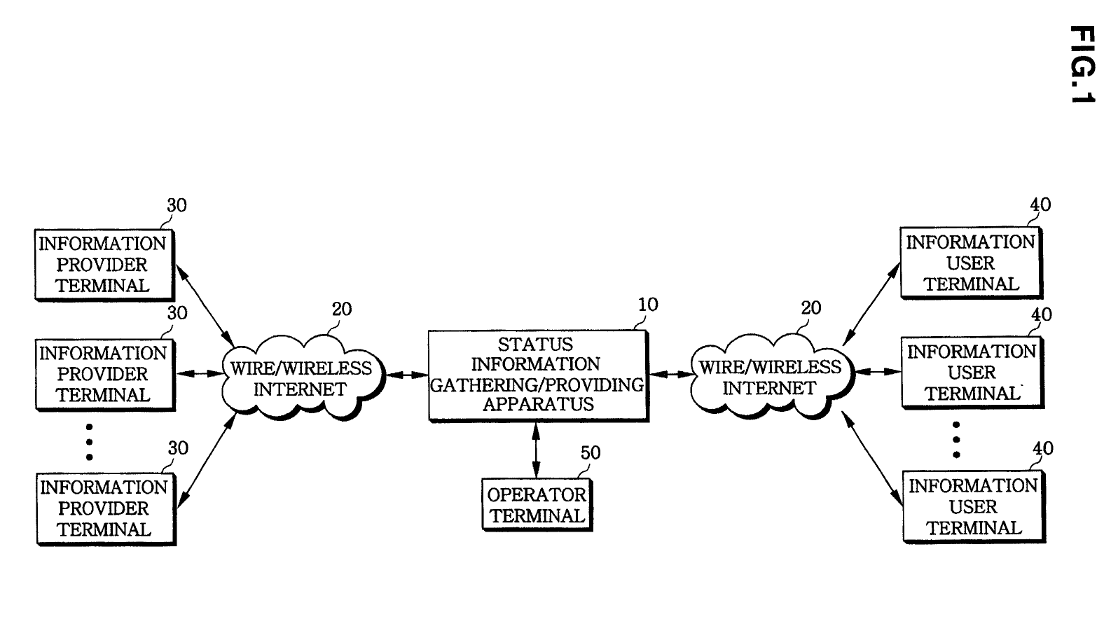

The operating environment of an apparatus for gathering and providing status information according to the present invention will be described first with reference to FIG. 1. Referring to FIG. 1, a status information gathering/providing apparatus 10 according to the present invention gathers status information from one or more information provider terminals 30 connected thereto through a wire/wireless Internet 20 and provides status information selected by one or more information users to one or more information user terminals 40 through the wire/wireless Internet 20.

The wire/wireless Internet 20 is used in a broad sense, that is, it includes Internet as a computer communication network connected throughout the world using Transmission Control Protocol/Internet Protocol (TCP/IP) and all types of wire/wireless communication networks through which the status information gathering/providing apparatus 10 is connected to at least one wire/wireless terminal and which are linked to the Internet.

The information provider terminals 30 include all types of terminals that can be provided for information providers and can gather status information in real time, encode the gathered status information according to a predetermined method, and transmit the status information to the status information gathering/providing apparatus 10 through the wire/wireless Internet 20 using a streaming method. Accordingly, in the present invention, each of the information provider terminals 30 is preferably a portable wireless terminal which can be easily carried with an information provider and is provided with a digital camera (not shown) for generating video data contained in status information and a communication interface (not shown) for accessing the status information gathering/providing apparatus 10 through the wire/wireless Internet 20 and transmitting the status information in real time using a streaming method. The information provider terminals 30 can transmit gathered status information to the status information gathering/providing apparatus 10 in real time or can record the status information and add text data to the recorded status information before transmitting it to the status information gathering/providing apparatus 10. The structure of the information provider terminals 30 is beyond the scope of the present invention. Thus, a detailed description thereof will be omitted.

The information user terminals 40 include all types of terminals (for example, PCs, PDAs, cellular phones and IMT2000 terminals) that can be provided for information users and can access the status information gathering/providing apparatus 10 through the wire/wireless Internet 20 and receive status information using a streaming method. Accordingly, in the present invention, each of the information user terminals 40 is preferably a wire/wireless terminal which is provided with a browser program (not shown) for accessing the wire/wireless Internet 20 to access the status information gathering/providing apparatus 10 and a media player program (not shown) for receiving status information using a streaming method corresponding to a status information transmission method used by the status information gathering/providing apparatus 10. The structure of the information user terminals 40 is beyond the scope of the present invention. Thus, a detailed description thereof will be omitted.

An operator can access and manage programs and data provided in the status information gathering/providing apparatus 10 using an operator terminal 50 which is connected to the status information gathering/providing apparatus 10 through a local area network (LAN). It can be appreciated that the status information gathering/providing apparatus 10 and the operator terminal 50 are in a server-client relationship.

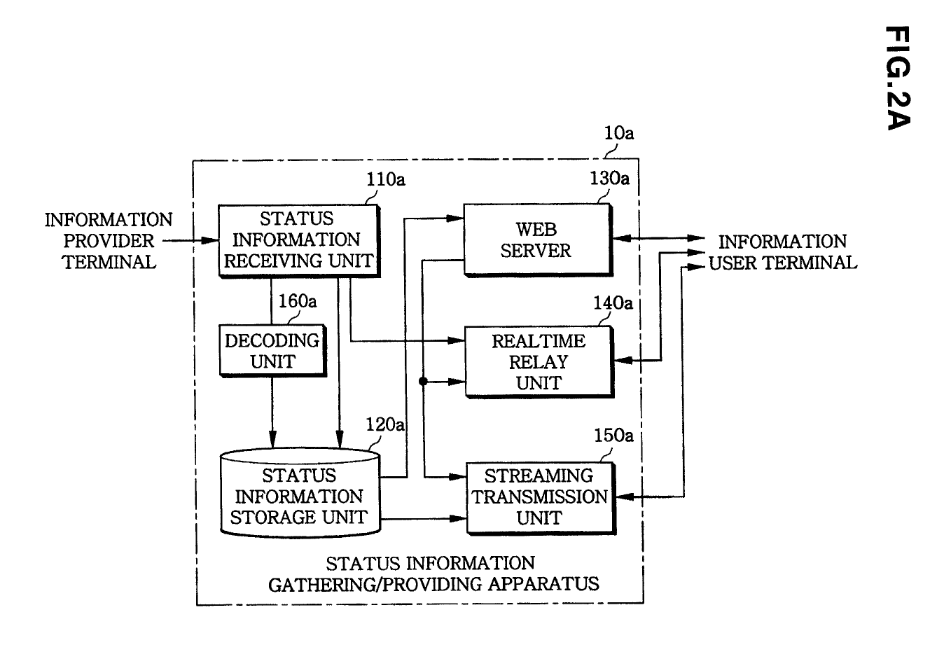

Referring to FIG. 2A, a status information gathering/providing apparatus 10a according to a first embodiment of the present invention includes a status information receiving unit 110a, a status information storage unit 120a, a decoding unit 160a, a web server 130a, a realtime relay unit 140a, and a streaming transmission unit 150a.

The status information receiving unit 110a receives status information that is classified by districts and themes from at least one information provider terminal 30 through the wire/wireless Internet 20 using a streaming method. Here, the status information may be composed of video data only gathered through a camera provided in the information provider terminal 30 or may be composed by combining video data and audio data which is gathered through a microphone provided in the information provider terminal 30 or text data which is input by an information provider. Video data contained in status information is encoded by a video codec employing one of standards such as Moving Picture Experts Group-1 (MPEG-1), MPEG-2, MPEG-3, International Telecommunications Union-Telecommunication Standardization Sector (ITU-TSS) H.263, and Windows Media Player (WMP). Audio data contained in status information is encoded by one of audio codecs such as MPEG-1 Audio Layer 3 (MP3), Windows Media Audio (WMA) codec, MPEG-2 Advanced Audio Coding (MPEG-2 MC), Dolby digital, MPEG-4 audio, and voice codec. The encoded video data and audio data are transmitted to the status information gathering/providing apparatus 10a using a predetermined streaming method. A video codec, an audio codec, and a streaming method which are used in the present invention are not restricted to particular ones, and the status information receiving unit 110a can employ any video and audio codecs and streaming method which are currently used or which can be used in the future without departing from the scope of the present invention.

The status information storage unit 120a classifies status information received through the status information receiving unit 110a by districts and themes and stores the status information in order of time (i.e., generation time when status information is generated or reception time when status information is received). Here, district information and theme information used for classifying the status information are provided from the at least one information provider terminal 30 that provides the status information. When the information provider terminal 30 provides recorded status information to the status information gathering/providing apparatus 10a, generation time information is provided together with the status information. When the information provider terminal 30 does not provide extra time information in such a case where it provides the status information to the status information gathering/providing apparatus 10a in real time, a reception time when the status information receiving unit 110a completes the reception of the status information can be used as time information. The status information storage unit 120a includes a storage medium (for example, a hard disc, an optical disc, or a memory) for storing the status information and a database management program for storing the status information in the storage medium or retrieving the status information from the storage medium.

The decoding unit 160a decodes status information received through the status information receiving unit 110a. While decoding the status information that is received and transmitted in real time, the decoding unit 160a generates still images at predetermined intervals and stores the still images in the status information storage unit 120a. When realtime reception of the status information is completed, the decoding unit 160a selects a representative still image from among the still images generated for the status information and stores it in the status information storage unit 120a. For example, in the case where the status information that is received and transmitted in real time is encoded according to an MPEG-4 method, the decoding unit 160a can search and decode lntraframe-Video Object Planes (I-VOPs) at intervals of 10 seconds to generate still images and can select a still image, which is generated first, as a representative still image.

The web server 130a provides a web page for receiving a status information reception request signal from at least one of the information user terminals 40. More specifically, the web server 130a posts still images indicating different kinds of status information relayed in real time and representative still images indicating status information of different classification items stored in the status information storage unit 120a on the web page. Accordingly, an information user can selectively receive status information, which is relayed in real time or stored by classification items in the status information storage unit 120a, by clicking a still image or representative still image displayed on a screen of the user's information user terminal 40 using a mouse, that is, by generating a status information reception request signal. Then, the web server 130a analyzes the status information reception request signal transmitted from the information user terminal 40 and generates a realtime relay request signal or a streaming transmission request signal.

The web server 130a can provide a web page for receiving district information and theme information used for classifying the status information that is transmitted from the at least one information provider terminal 30 to the information provider terminal 30.

The realtime relay unit 140a receives the realtime relay request signal from the web server 130a, receives the status information selected by the information user from the status information receiving unit 110, and relays the status information to the user's information user terminal 40 in real time. When the status information is transmitted to the information user terminal 40 in real time using a streaming method, the realtime relay unit 140 can employ various methods such as unicasting, multicasting, and web casting. However, in order to efficiently use a bandwidth, it is preferable to relay the status information according to multicasting. For this, the realtime relay request signal transmitted from the web server 130a contains an IP address of each of the information user terminals 40 requesting the reception of the status information, and the realtime relay unit 140a manages IP addresses of all information user terminals 40 requesting realtime relay.

The streaming transmission unit 150a receives the streaming transmission request signal from the web server 130a, retrieves the status information of a classification item selected by the information user from the status information storage unit 120a, and transmits the status information to the information user terminal 40 of the user requesting the reception of the status information using a streaming method. Since different kinds of streaming data are transmitted to different information user terminals at a particular time, the streaming transmission unit 150a preferably employs unicasting.

In the first embodiment of the present invention shown in FIG. 2A, the decoding unit 160a is optional. When the decoding unit 160a is not provided in the first embodiment, the web server 130a can indicate status information, which can be relay in real time or can be transmitted using a streaming method, on the web page using text data contained in the status information, instead of using still images or representative still images which are generated by the decoding unit 160a.

Referring to FIG. 2B, a status information gathering/providing apparatus 10b according to a second embodiment of the present invention includes a status information receiving unit 110b, a status information storage unit 120b, a decoding unit 160b, a web server 130b, a realtime relay unit 140b, a streaming transmission unit 150b, an information provider management unit 170, and a certification unit 180. The functions of the status information receiving unit 110b, the status information storage unit 120b, the decoding unit 160b, the web server 130b, the realtime relay unit 140b, and the streaming transmission unit 150b shown in FIG. 2B are similar to the functions of the status information receiving unit 110a, the status information storage unit 120a, the decoding unit 160a, the web server 130a, the realtime relay unit 140a, and the streaming transmission unit 150a shown in FIG. 2A, and thus descriptions thereof will be omitted, and only the information provider management unit 170 and the certification unit 180 will be described in detail below.

The information provider management unit 170 is an element for computing pay information to pay an information provider for the providing of status information to the status information gathering/providing apparatus 10b. In the case where status information received by the status information receiving unit 110 contains information provider information, the information provider management unit 170 counts the number of times that a relevant information provider has uploaded status information and the number of times that status information provided by the relevant information provider has been hit, referring to the information provider information. The information provider management unit 170 computing pay information for each information provider based on the results of the counting, stores them in a predetermined storage medium (for example, a hard disc, an optical disc, or a memory), and manages them.

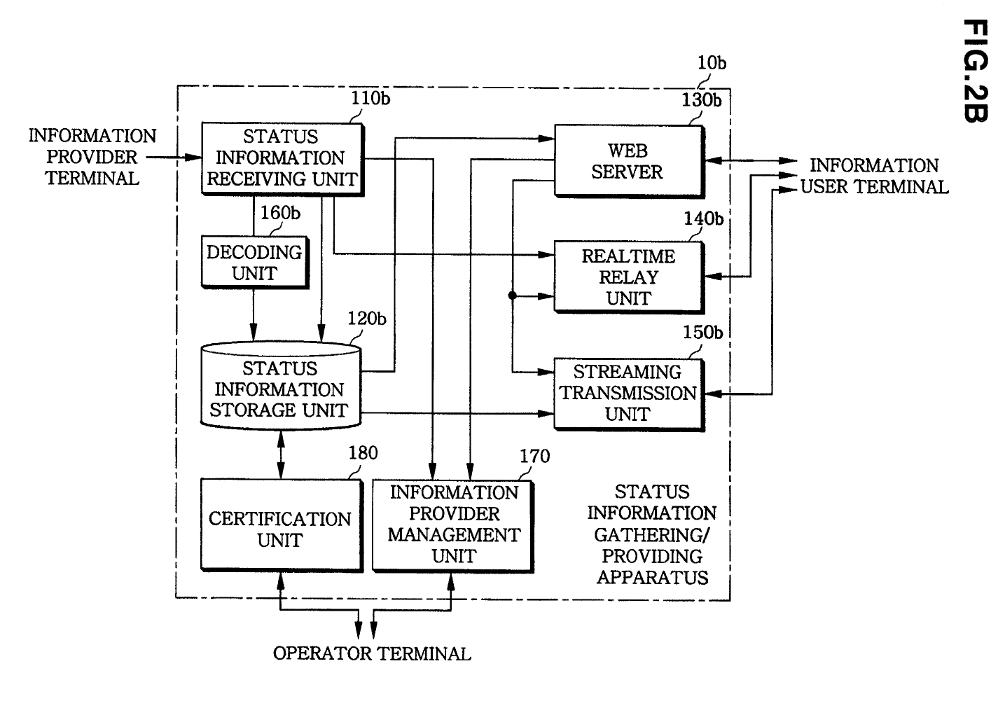

FIG. 3 is a schematic diagram showing an example of a structure of information provider information managed by the information provider management unit 170. Information provider information, which is generated, stored, and managed by the information provider management unit 170, includes an information provider identifier field 60 for identifying an information provider, an information upload count field 61 for storing the number of times that a relevant information provider has uploaded status information, a hit count field 62 for storing the number of times that status information provided by the relevant information provider has been hit, and a pay field 63 for storing pay information computed based on the number of uploads and the number of hits. Accordingly, an operator of the status information gathering/providing apparatus 10b can refer the information provider information transmitted from the information provider management unit 170 through the operator terminal 50 and can pay each information provider for provision of status information. A payment process may be automatically performed in association with a predetermined banking system. This is beyond the scope of the present invention, so a detailed description thereof will be omitted.

Referring back to FIG. 2B, the certification unit 180 transmits status information stored in the status information storage unit 120b to the operator terminal 50 connected thereto, receives certification information corresponding to the transmitted status information from the operator terminal 50, and records the certification information in the status information storage unit 120b. More specifically, the operator of the status information gathering/providing apparatus 10b detects the theme of the status information stored in the status information storage unit 120b through the operator terminal 50 and performs certification on the status information when certification information is needed in terms of theme (for example, when the status information is a target of criticism of obscenity). In addition, the certification unit 180 provides an environment under which the operator of the status information gathering/providing apparatus 10b can perform certification on status information that is being relayed in real time by the realtime relay unit 140b and can be configured to interrupt relay of status information that is inappropriate for realtime relay.

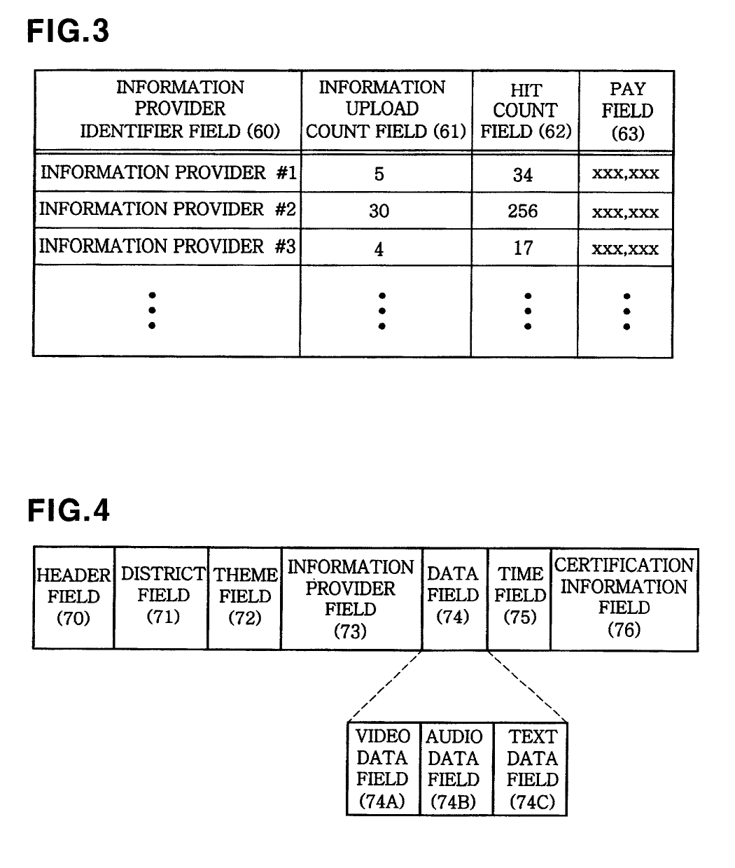

FIG. 4 is a diagram showing an example of a structure of status information data managed by the status information storage units 120a and 120b of the status information gathering/providing apparatuses 10a and 10b according to the present invention. Referring to FIG. 4, status information data managed by the status information storage units 120a and 120b includes a header field 70 for storing an identifier of relevant data, a district field 71 for storing a district where the status information data is generated, a theme field 72 for storing a theme of the status information data, an information provider field 73 for storing an information provider who generates the status information data, a data field 74 for storing content of status information composed of video and/or audio streaming data or composed of combination of video and/or audio streaming data and text data, a time field 75 for storing a time when the status information is generated, and a certification information field 76 for storing the result of certification in the case where the status information needs to be certified.

Information stored in the district field 71, the theme field 72, and the information provider field 73 is provided prior to the data field 74 from the information provider terminal 30 and is preferably coded by a predetermined method.

The data field 74 conceptionally includes at least one among a video data field 74a for video data, an audio data field 74b for audio data, and a text data field 74c for text data. However, actually, the video data field 74a and the audio data field 74b are composed of at least one streaming data blocks. Each of the streaming data blocks is composed of a block header indicating an attribute of the corresponding block and a block data (system data, video data, or audio data). The size of the data field 74 varies with the volume of status information.

The time field 75 stores time information about a time where the status information is generated. The time information is determined by the information provider terminal 30 based on a time when the status information is actually generated. In the case where the time information is not provided from the information provider terminal 30, time information can be determined based on a time when the status information receiving unit 110a or 110b starts or completes reception of the status information.

The operator of the status information gathering/providing apparatus 10b can regularly or irregularly check status information stored in the status information storage unit 120b through the certification unit 180 and records a proper value in the certification information field 75 of the status information.

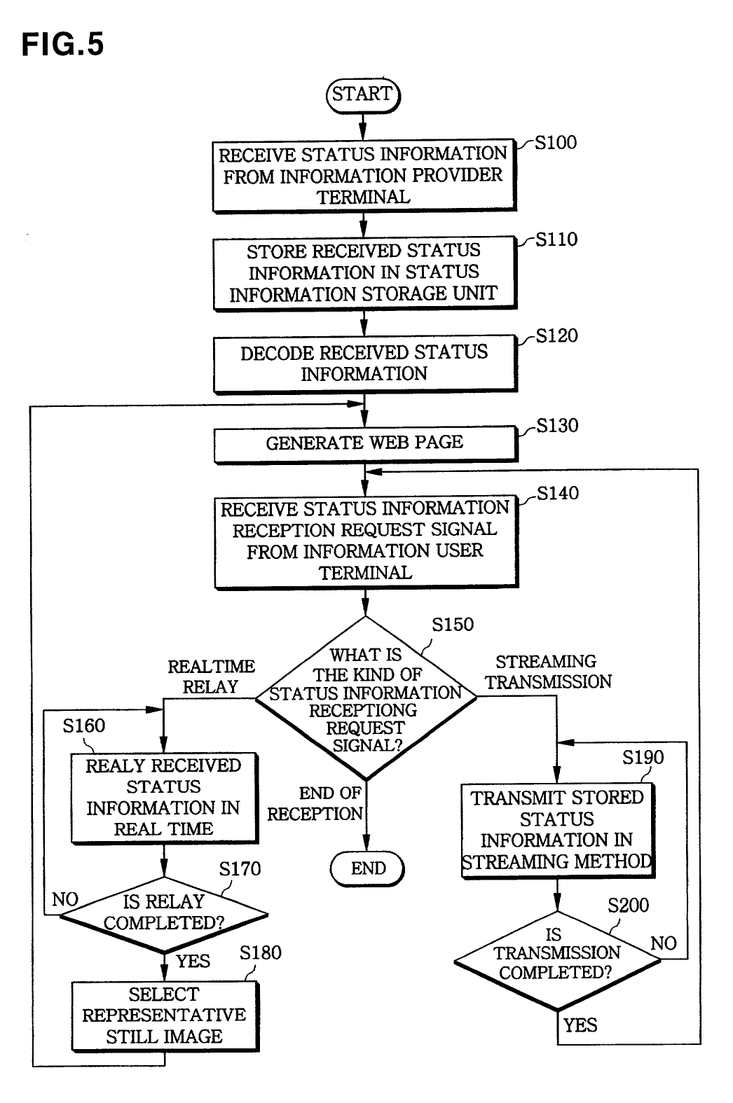

Hereinafter, a procedure for processing status information according to the present invention will be described in detail with reference to FIG. 5.

In step S100, a status information gathering/providing apparatus according to the present invention receives status information, which is classified by districts and themes, from at least one information provider terminal through a communication network in a streaming method. Here, a web server of the status information gathering/providing apparatus may provide a web page, through which district information and theme information used for classification of the status information transmitted from the at least one information provider terminal can be received, to the at least one information provider terminal. At least one information provider can receive the web page from the web server through his/her information provider terminal and determine the district and theme information corresponding to the status information on the web page.

In step S110, the received status information is stored by districts and themes in a status information storage unit in order of time based on time information. Here, since video data contained in the status information received in real time has been encoded by a predetermined method, in step S120 a decoding unit decodes the received status information, generates still images at predetermined intervals, and stores the decoded status information and the still images by information providers in the status information storage unit. In step S130, the web server generates a web page, through which a status information reception request signal is received, using the still images stored in the status information storage unit. The still images indicating the status information under realtime relay are posted on the web page and are updated at predetermined time intervals.

In step S140, at least one information user can generate a status information reception request signal by selecting and clicking a still image, which indicates status information desired among the still images indicating status information under realtime relay on the web page provided by the web server, using a mouse in the user's information user terminal. In step S150, the web server analyzes the status information reception request signal received from the user information terminal and generates a realtime relay request signal.

In step S160, a realtime relay unit of the status information gathering/providing apparatus receives the realtime relay request signal from the web server, receives the status information, which is selected in response to the status information reception request signal, from the status information receiving unit, relays the status information to the user information terminal requesting the status information in real time according to a multicasting method. For this, the realtime relay unit manages IP addresses of all information user terminals requesting realtime relay, and the realtime relay request signal transmitted from the web server contains an IP address of an information user terminal requesting reception of status information.

For the status information whose realtime reception is completed, a firstly generated still image is selected as a representative still image for the status information in steps S170 and 180. Selecting a firstly generated still image as a representative image is just an example, and the present invention is not restricted thereto. Representative still images are classified according to the classification items of status information and are stored in the status information storage unit.

Meanwhile, in step S130 the web page generates the web page, through which the status information reception request signal is received, using the representative still images stored in the status information storage unit. More specifically, the web server posts still images indicating status information under realtime relay on the web page to receive a realtime relay request from an information user terminal and posts the representative still images indicating status information of different classification items stored in the status information storage unit on the web page to receive a streaming transmission request from an information user terminal. A representative still image indicating the latest status information of each classification item is posted on the web page prior to status information generated before. The status information generated before is posted such that they can be searched in descending order of time. Here, a value recorded in the time field 75 shown in FIG. 4 is used as a time referred to.

In step S140, at least one information user can generate a status information reception request signal by selecting and clicking a representative still image, which indicates status information desired to be transmitted in a streaming method among the representative still images classified by districts and themes on the web page provided by the web server, using a mouse in the user's information user terminal. In step S150, the web server analyzes the status information reception request signal received from the user information terminal and generates a streaming transmission request signal.

A streaming transmission unit receives the streaming transmission request signal from the web server, retrieves status information of a classification item selected in response to the status information reception request signal from the status information storage unit, and transmits the status information to the information user terminal requesting the reception of the status information in a streaming method in step S190. The streaming transmission unit transmits the status information according to a unicasting method. For this, the streaming transmission unit manages IP addresses of all information user terminals requesting streaming transmission, and the streaming transmission request signal transmitted from the web server contains an IP address of the information user terminal requesting the reception of the status information.

If the streaming transmission is completed in step S200, the information user may select other status information on the web page provided by the web server to receive it or terminate the reception of status information.

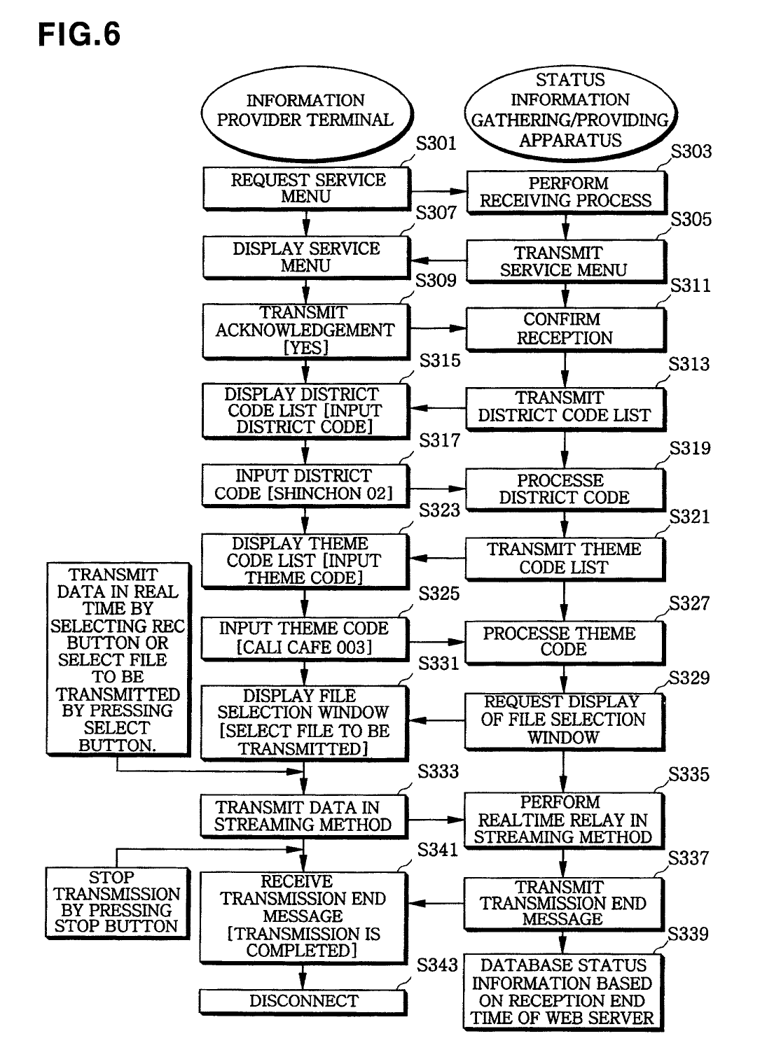

FIG. 6 is a diagram showing an example of a procedure in which an information provider terminal transmits status information to a status information gathering/providing apparatus according to the present invention.

Referring to FIG. 6, in transmitting status information to the status information gathering/providing apparatus in a streaming method using an information provider terminal, the information provider terminal transmits a service menu request message to the status information gathering/providing apparatus in step S301.

Then, the status information gathering/providing apparatus perform a receiving process on the service menu request message in step S303 and transmits a service menu as a response to the request message in step S305.

The information provider terminal receives the service menu and displays the content of the service menu in step S307 and transmits acknowledgement (“Yes”) in step S309. The status information gathering/providing apparatus confirms based on the acknowledgement that the information provider terminal has received the service menu in step S311 and transmits a district code list containing information about codes of individual districts to the information provider terminal in step S313.

The information provider terminal receives the district code list, displays it on a screen, and displays a message (for example, “Input a district code.”) which guides an information provider to input a relevant district code in step S315 and is on standby until the information provider inputs the district code. If the information provider inputs the district code (for example, “Shinchon 02”), the information provider terminal transmits the code information to the status information gathering/providing apparatus in step S317. The status information gathering/providing apparatus receives and process the district code in step S319 and transmits a theme code list containing information about codes of individual themes to the information provider terminal in step S321.

The information provider terminal receives and displays the theme code list on the screen and displays a message (for example, “Input a theme code.”) which guides the information provider to input a relevant theme code in step S323. Then, the information provider terminal is on standby until the information provider inputs the theme code. If the information provider inputs the theme code (for example, “Cali cafe 003”), the information provider terminal transmits the code information to the status information gathering/providing apparatus in step S325. The status information gathering/providing apparatus receives and process the theme code in step S327 and requests the information provider terminal to display a “file selection window” on the screen of the information provider terminal in step S329. The file selection window allows the information provider to select a file containing status information to be transmitted from the information provider terminal.

The information provider terminal receives the request and displays the file selection window on the screen in step S331. Then, it is on standby until the information provider selects a desired file.

If the information provider presses a predetermined button (for example, an “REC” button) for transmitting status information in real time, the information provider terminal transmits video data gathered through a camera and audio data gathered through a microphone to the status information gathering/providing apparatus in a realtime streaming method in step S333. The realtime status information is transmitted in a streaming method until the information provider presses a predetermined button (for example, a “STOP” button) for stopping transmission of realtime status information.

If the information provider presses a predetermined button (for example, a “SELECT” button) for transmitting status information which is recorded in advance in a storage unit of the information provider terminal, the information provider terminal retrieves status information of the selected file from the storage unit and transmits the retrieved status information to the status information gathering/providing apparatus in a streaming method. Streaming transmission of the status information stored in the storage unit is continued until the content of the status file is completely transmitted or until the information provider presses the predetermined button (e.g., the “STOP” button) for stopping the transmission of the status information.

The status information gathering/providing apparatus relays the status information, which is transmitted in real time, to an information user terminal that requests the status information in real time in step S335. When the streaming transmission from the information provider terminal is completed, the status information gathering/providing apparatus transmits a transmission end message to the information provider terminal in step S337 and builds up the database of the received status information based on a generation time when the status information is generated or a reception end time when the reception of the status information is completed in step S339.

In the meantime, the information provider terminal receives and displays the transmission end message (for example, “Transmission is completed”) in step S341 and breaks the connection to the status information gathering/providing apparatus in step S343.

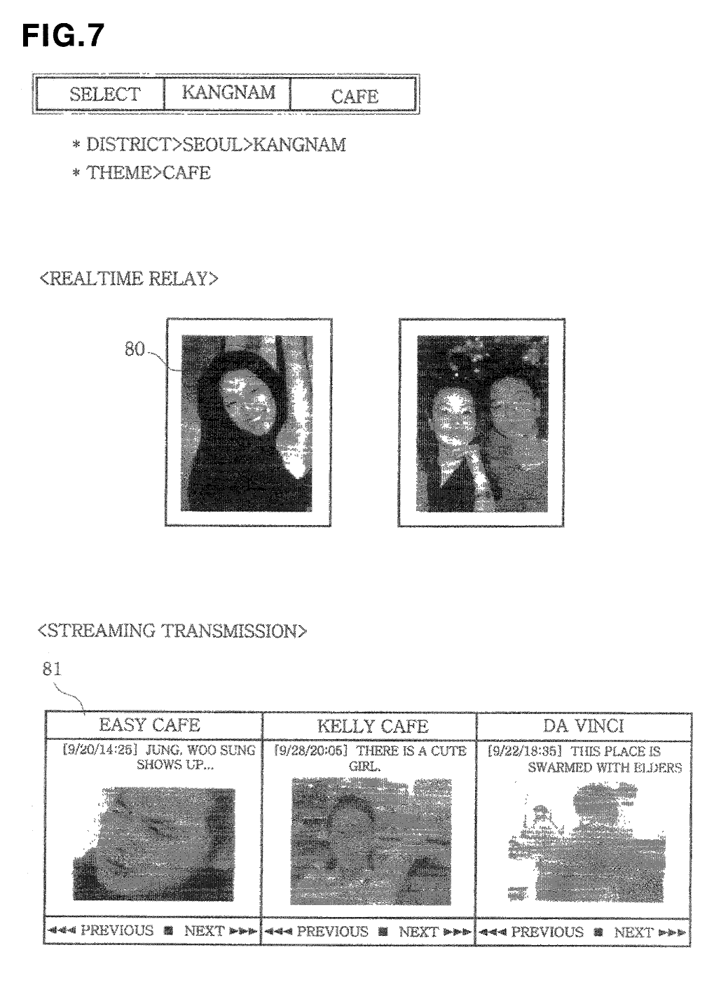

FIG. 7 shows an example of a web page which a web server of a status information gathering/providing apparatus according to the present invention provides to an information user terminal. Referring to FIG. 7, an information user can select and check status information only corresponding to desired district and theme on the web page.

Reference numeral 80 denotes still images indicating status information under realtime relay, and reference numeral 81 denotes representative still images of status information of which the realtime relay has been completed and classified by districts and themes in order of time (generation time or reception time). Here, the still images 80 are updated at predetermined time intervals. In addition, the representative still images 81 of latest status information are posted on the web page by districts and themes by default, and representative still images of status information that has been completely received in advance can be checked in descending order of time by selection of an information user (for example, by selecting a “PREVIOUS” button).

As described above, according to an apparatus for gathering and providing status information and a method for processing the status information of the present invention, status information which is transmitted in real time by a number of unspecified information providers can be easily provided to a number of unspecified information users using a streaming method so that an entire procedure from data gathering to service providing can be effectively performed in real time without expending great deal in classifying, selecting, and/or editing information.

In addition, according to the present invention, status information which has gone through realtime relay can be sequentially checked by districts and themes in descending order of time starting from the latest one so that information users who have not checked the status information in real time can check desired information as quickly as possible.

While this invention has been particularly shown and described with reference to preferred embodiments thereof, it will be understood by those skilled in the art that various changes may be made therein without departing from the scope of the invention. Therefore, the above-described embodiments will be considered not in restrictive sense but in descriptive sense only. The scope of the invention will be defined not by the above description but by the appended claims, and it will be construed that all differences made within the scope defined by the claims are included in the present invention.

What is claimed is:

1. An apparatus for gathering and providing status information for a number of unspecified users, the apparatus comprising:
a status information receiving unit for receiving status information, which is classified by districts and themes, from at least one information provider terminal through a communication network in a streaming method;
a status information storage unit for storing the status information received through the status information receiving unit by districts and themes in order of status information generation time or status information reception time;
a web server for providing a web page through which a status information reception request signal is received from at least one information user terminal, analyzing the received status information reception request signal, and generating a realtime relay request signal or a streaming transmission request signal;
a realtime relay unit for receiving the realtime relay request signal from the web server, receiving status information, which is selected by at least one information user from among the status information which is being received in real time, from the status information receiving unit, and relaying the selected status information to the at least one information user terminal requesting the reception in real time; and
a streaming transmission unit for receiving the streaming transmission signal from the web server, retrieving status information of a classification item selected by the information user from the status information storage unit, and transmitting the status information to the at least one information user terminal requesting the reception in a streaming method.

2. The apparatus of claim 1, wherein the realtime relay unit receives the status information, which is selected by the at least one information user from among the status information which is being received in real time, from the status information receiving unit and relays the status information to all information user terminals requesting the reception in real time according to a multicasting method.

3. The apparatus of claim 1, further comprising a decoding unit for receiving the status information, which is being received in real time, from the status information receiving unit, decoding the status information, generating still images at predetermined intervals, and selecting a representative still image from among the still images generated for each piece of status information which has been completely received.

4. The apparatus of claim 3, wherein the web server posts the still images indicating the status information being under realtime relay on the web page, posts representative still images indicating status information of different classification items stored in the status information storage unit on the web page, and receives the status information reception request signal from the at least one information user terminal.

5. The apparatus of claim 4, wherein the web server posts representative still images indicating latest status information by classification items prior to other representative still images of previous status information and sequentially posts the representative still images of the previous status information in descending order of time according to selection of the information user.

6. A method for processing status information, comprising the steps of:
receiving status information, which is classified by districts and themes, from at an information provider terminal through a communication network in a streaming method;
storing the status information in a status information storage unit by districts and themes in order of status information generation time or status information reception time;
generating still images while decoding the status information which is received in real time and posting the still images on a web page to indicate status information which can be relayed in real time; and
relaying status information corresponding to a still image selected by an information user from among the still images posted on the web page to the information user's terminal.

7. The method of claim 6, wherein the still images are generated at predetermined intervals.

8. The method of claim 6, wherein the status information is relayed in real time to all information user terminals, which request reception of the status information, according to a multicasting method.

9. The method of claim 6, further comprising the steps of:
selecting a representative still image for each piece of status information whose realtime reception is completed and posting the representative still image in a corresponding classification item on the web page; and
retrieving status information, which corresponds to a representative still image selected by an information user from among representative still images posted on the web page, from the status information storage unit and transmitting the status information to the information user's terminal in a streaming method.

10. The method of claim 9, wherein representative still images indicating latest status information by classification items are posted prior to other representative still images of previous status information, and the representative still images of the previous status information are sequentially posted in descending order of time according to selection of the information user.
